(19) United States
(12) Patent Application Publication
(10) Pub. No.: US 2010/0067993 A1
(43) Pub. Date: Mar. 18, 2010

(54) Ladder Machine

(76) Inventor: Russell Merrick, (US)

Correspondence Address: Merrick Machine, Apollo Ave., P.O. Box 130, Alda, NE, 68810, US

(21) Appl. No.: 11/927,982

(22) Filed: Sep. 12, 2008

(51) Int. Cl. B23B 39/16

(52) U.S. Cl. 408/42

(57) ABSTRACT

This invention is intended for gang drilling a predetermined pattern of holes, accurately located in a specifically sized pocket or mortise pre-created by other means in a wooden member such as, but not limited by, a door or door jamb, in which the purpose of these holes is to aid in attaching other physical devices such as, but not limited to, hinges by means of common wood screws. This invention is comprised of a system of roller chain-driven spindles which contain appropriately sized twist drill bits, all driven from a centrally located spindle attached externally to a standard hand-drill. An appropriately sized spring-loaded guide plate fits easily into the pre-created pocket or mortise allowing positive positioning of the invention's assembly but allows access for the twist drills to pass through the guide plate, for the purpose of drilling into the wood.

This invention is intended for gang drilling a predetermined pattern of holes, accurately located in a specifically sized pocket or mortise pre-created by other means in a wooden member such as, but not limited by, a door or door jamb, in which the purpose of these holes is to aid in attaching other physical devices such as, but not limited to, hinges, by means of common wood screws. The common method for achieving this desired result is to hand mark the hole pattern in the pocket or mortise or use the physical device to “jig” the position of the hole pattern and drill each hole individually using a common hand drill with an appropriately sized twist drill bit. The common method is slow, cumbersome, and often erroneous due to marking errors or slippage when drilling each hole sequentially.

This invention is comprised of a system of roller chain-driven drill spindles which contain appropriately sized twist drill bits arranged in the predetermined pattern all driven from a centrally located drive spindle attached externally to a standard hand-drill. Each drill spindle and drive spindle is affixed within a common housing and restrained laterally by means of a pair of needle bearings and longitudinally by means of a thrust bearing on the load side and a collar on the non-load side. Each drill spindle is coupled to the roller chain by means of a sprocket permanently affixed thereupon in such a fashion as to provide clockwise rotation of all the drill spindles, as viewed from the rear. The drive spindle is coupled to the same roller chain in like manner by a sprocket permanently affixed thereupon in such a fashion as to provide motion and torque to the drill spindles as it rotates counter-clockwise as viewed from the rear. Rotating the drive spindle in the opposite direction as the drill spindles provides better chain engagement to the drive spindle and therefore higher torque carrying capacity. The roller chain is self connected to form a continuous loop and is tensioned by means of an adjustable idler sprocket. The entire assembly is attached to a common hand drill by means of the standard three-jawed chuck provided on the hand drill. The assembly of this invention provides an additional bracket which connects to the auxiliary clamp-on handle, also provided by the hand drill, for the purpose of preventing rotation of this invention relative to the hand drill.

This invention incorporates an appropriately sized spring-loaded guide plate which protrudes beyond the end of the drill bits in the relaxed position and easily fits in the pre-created pocket or mortise allowing positive positioning of the invention's assembly but allowing access for the twist drills to pass through the guide plate for the purpose of drilling into the wood. Applying a modest amount of force against the work surface by means of human hands pushing against the hand-drill, causes the springs to compress and provides the motion and thrust necessary to advance the drill bits into the wood. An adjustable hard-stop is provided to limit the amount of travel of the spring-loaded guide plate and thereby determines the maximum depth of the drilled holes. Removing the externally applied human force extracts the drill bits from the wood and allows the spring-loaded guide plate to return to its relaxed position.

1. This invention is intended for gang drilling a predetermined pattern of holes, accurately located in a specifically sized pocket or mortise pre-created by other means in a wooden member such as, but not limited by, a door or doorjamb, in which the purpose of these holes is to aid in attaching other physical devices such as, but not limited to, hinges by means of common wood screws.

2. This invention is comprised of a system of roller chain-driven spindles which contain appropriately sized twist drill bits arranged in the predetermined pattern all driven from a centrally located spindle attached externally to a standard hand-drill.

3. This invention incorporates an appropriately sized spring-loaded guide plate which protrudes beyond the end of the drill bits and easily fits in the pre-created pocket or mortise allowing positive positioning of the invention's assembly but allowing access for the twist drills to pass through the guide plate for the purpose of drilling into the wood.
